(19) United States
(12) Patent Application Publication
(10) Pub. No.: US 2015/0205860 A1
(43) Pub. Date: Jul. 23, 2015

(54) INFORMATION RETRIEVAL DEVICE, INFORMATION RETRIEVAL METHOD, AND INFORMATION RETRIEVAL PROGRAM

(71) Applicant: FUJITSU LIMITED, Kawasaki-shi (JP)

(72) Inventors: Seiji Okura, Meguro (JP); Akira Ushioda, Taito (JP)

(21) Appl. No.: 14/597,006

(22) Filed: Jan. 14, 2015

(30) Foreign Application Priority Data
Jan. 21, 2014 (JP) 2014-008962

(51) Int. Cl. G06F 17/30

(52) U.S. Cl. CPC G06F 17/30684; G06F 17/30011

(57) ABSTRACT

An information retrieval device includes a processor that executes processing including: breaking down a natural sentence into a plurality of words and creating retrieval keys from retrieval key candidates which each include two words out of the plurality of words, on the basis of the characteristics that are given to each of the two words; specifying the documents that include the retrieval keys, and calculating the evaluation values of the specified documents and the number of specified documents; recalculating the evaluation values of the documents that correspond to the retrieval keys that are determined to be noise, on the basis of the number of specified documents; and outputting the documents on the basis of the recalculated evaluation values.

### CROSS-REFERENCE TO RELATED APPLICATION

This application is based upon and claims the benefit of priority of the prior Japanese Patent Application No. 2014-008962, filed on Jan. 21, 2014, the entire contents of which are incorporated herein by reference.

### FIELD

The embodiments discussed herein are related to an information retrieval device, an information retrieval method, and an information retrieval program.

### BACKGROUND

Recently, due to the advance of information and communication technology (IT), numerous computerized documents have been accumulated in databases. With the objective of utilization of those databases, information retrieval techniques for retrieving documents that have a meaning close to that of an input sentence that is a natural sentence have attracted attention.

For example, a technique is known wherein documents that are common to a plurality of retrieval conditions are retrieved and the relationship between the retrieval conditions is determined in each document, and only documents in which the retrieval conditions are determined to be relevant to each other are output or displayed (For example, patent document 1). Thus, by narrowing down retrieval documents, retrieval precision can be improved.

In addition, a technique is known wherein a retrieval condition that is input by a user is analyzed, the connection between the words that are included in the retrieval condition and the connection between the words that are included in accumulated documents are acquired, and a document that meets the input retrieval condition is selected on the basis of the degree of similarity between the two connections (for example, patent document 2). For example, by considering both the connection between content and a term and the connection between a term and another term even if a term has multiple meanings, the degree of similarity in the content that relates to the terms that a user usually uses increases, and the content that is close to the user's preference can be displayed at a higher rank.

A technique is also known wherein the degree of similarity between a natural sentence that is included in a retrieval condition and a document that is a retrieval target is checked, and a retrieval result with a similarity ranking is output (for example, patent document 3). For example, keywords for retrieval are extracted, and are classified into a main type that is related to a core theme that the sentence that is included in the retrieval condition expresses, and a minor type that is related to supplementary information on the basis of an attribution of the keyword. Then, document retrieval processing is executed on the basis of the classification result. In such a technique, processing on a keyword can be flexibly changed depending on the keyword type after classification, and document retrieval considering the type of a sentence that is included in a retrieval condition is possible.

Furthermore, an information retrieval system is known wherein processing is executed so that different information item groups are mapped onto respective nodes in a node array on the basis of interconnections, and therefore a similar information item is mapped onto a node of a similar position in the node array (for example, patent document 4).

In general, in information retrieval, precision and recall are in a trade-off relationship. Precision relates to an accuracy rate as to whether or not documents to be retrieved are retrieved. Recall relates to the degree of absence of retrieval omissions. For example, if retrieval omissions are prevented, that is, if recall is improved, precision is decreased.

In addition, a technique is known wherein a retrieval formula is created using many keywords that seem to be related to a document that is desired by a user, in order to prevent retrieval omissions such as overlooking of the desired document, since many documents that are not desired by the user are included in the retrieval result. However, when documents are retrieved on the basis of the retrieval formula, there are cases in which so much retrieval noise and so much retrieval junk are included in the retrieval result. Therefore, a technique is known wherein a natural language expression that is input for document retrieval is converted into a semantic structure, a retrieval formula is created from the semantic structure, documents are retrieved using the retrieval formula, and documents that include the result obtained by converting the natural language expression into the semantic structure are retrieved from the retrieved documents (for example, patent document 5).
Patent document 1: Japanese Laid-open Patent Publication No. 2003-085203
Patent document 2: Japanese Laid-open Patent Publication No. 2012-003603
Patent document 3: Japanese Laid-open Patent Publication No. 2004-139553
Patent document 4: Japanese Laid-open Patent Publication No. 2004-110834
Patent document 5: Japanese Laid-open Patent Publication No. 06-231178

### SUMMARY

An information retrieval device is disclosed. The information retrieval device includes a retrieval key creation unit configured to break down a natural sentence into a plurality of words, and to create retrieval keys from retrieval key candidates which each include two words out of the plurality of words, on the basis of characteristics that are given to each of the two words, a retrieval unit configured to specify documents that include the retrieval keys and to calculate the evaluation values of the specified documents and the number of specified documents, an evaluation value recalculation unit configured to recalculate the evaluation values of the documents that correspond to the retrieval keys that are determined to be noise, on the basis of the number of specified documents, and an output unit configured to output the documents on the basis of the recalculated evaluation values.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram explaining an outline of information retrieval that uses a semantic structure.

FIG. 2 is a diagram explaining an outline of information retrieval that uses a semantic structure.

FIG. 3 is a diagram explaining an outline of a practical example that includes removal of the influence of retrieval keys that become noise, and automatic determination of the noise.

FIG. 4 is a diagram illustrating an example of a functional block of an information retrieval device.

FIG. 5 is a diagram illustrating an example of data that is stored in an evaluation value table.

FIG. 6 is a diagram illustrating an example of data that is stored in a list of combinations of parts of speech.

FIG. 7 is a diagram explaining an outline of a semantic analysis.

FIG. 8 is a diagram explaining an example of a morphological analysis.

FIG. 9 is a diagram explaining an outline of creating retrieval key candidates.

FIG. 10 is a diagram explaining examples of retrieval candidates.

FIGS. 11A and 11B are a diagram explaining an outline of removal of the influence of retrieval keys that become noise.

FIG. 12 is a diagram explaining an outline of automatic determination of noise.

FIG. 13 is a diagram explaining recalculation of the evaluation values of the documents.

FIG. 14 is a diagram illustrating an example of a configuration of an information retrieval device.

FIG. 15 is a diagram illustrating an example of a flow of processing of an information retrieval method.

### DESCRIPTION OF EMBODIMENT

In information retrieval that analyzes the natural sentence included in the retrieval condition and uses a semantic structure that represents the meaning of a natural sentence with the meanings of words and a relationship between the words, in retrieval based on perfect matching of semantic minimum units, which are minimum partial structures of the semantic structure, there is a problem wherein there are retrieval omissions in which a semantic minimum unit does not match that in the document to be matched.

It is an object in the embodiments to prevent retrieval omissions while maintaining precision even in information retrieval that uses the semantic structure.

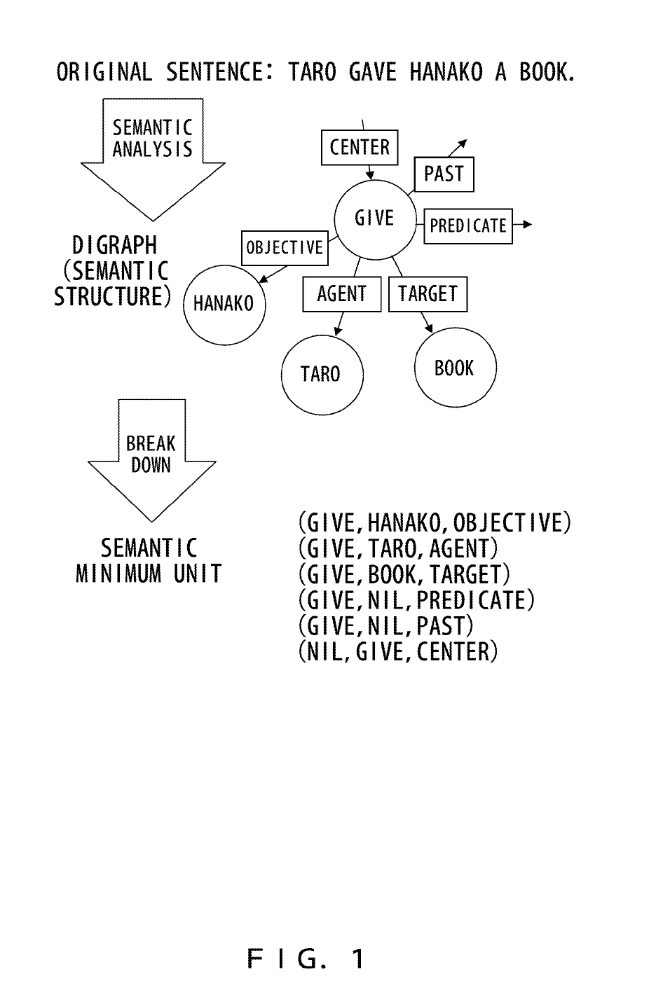

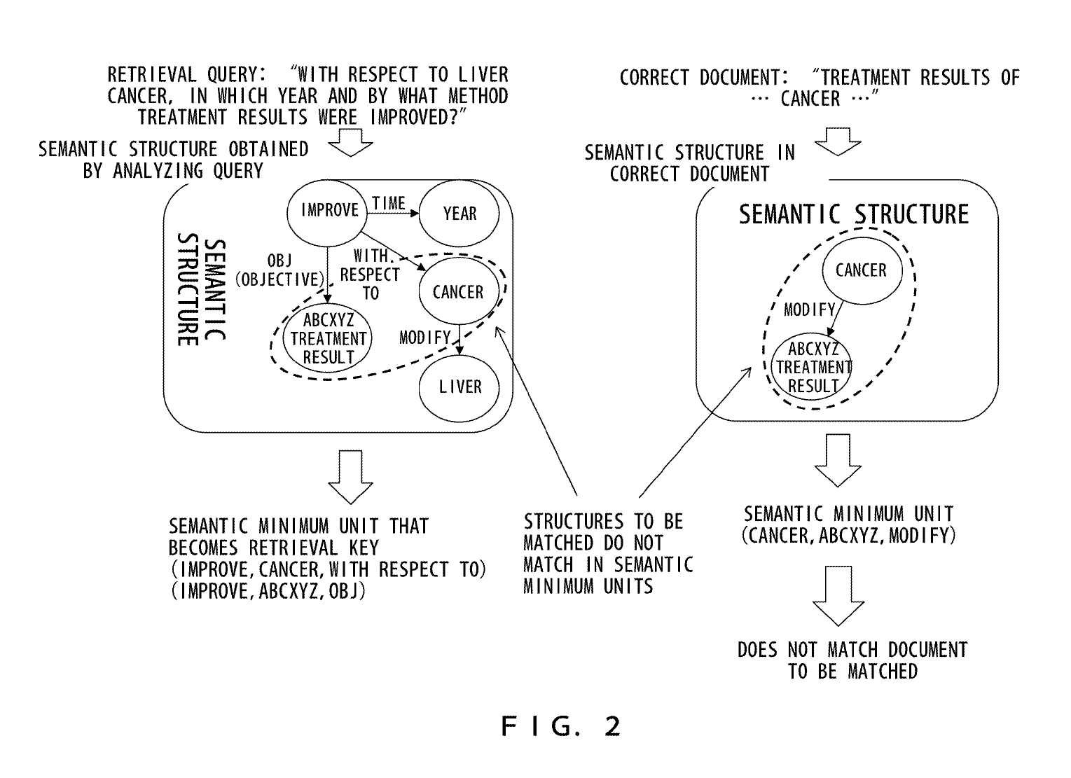

FIGS. 1-2 are each a diagram explaining an outline of information retrieval using the semantic structure.

For example, it is assumed that a natural sentence that is included in a retrieval condition is “Taro gave Hanako a book.” At that time, it can also be said that the original sentence is “Taro gave Hanako a book.” The original sentence is semantically analyzed, and as a result, the semantic structure, which is depicted in a digraph, is obtained.

Here, the term “semantic structure” means representing the meaning of a sentence with a digraph that is constituted of nodes which each show a semantic symbol that represents the meaning of a word, and arcs which each represent the relationship between words by analyzing the natural sentence.

A node represents the meaning (concept) of a word in an original sentence. In the example illustrated in FIG. 1, “give” “book” “Taro” and “Hanako” are nodes. Each node is given a symbol (concept symbol) that represents its concept. “GIVE” “BOOK” “TARO” and “HANAKO” are concept symbols.

An arc represents the relationship between nodes or the role of a node. If an arc is positioned between two nodes, the arc represents the relationship between the two nodes. For example, the arc drawn from the node that represents “give” to the node that represents “book” in the digraph illustrated in FIG. 1 is given an attribute “target.” An attribute may also be referred to as a name. For example, the name of the arc drawn from the node that represents “give” to the node that represents “book” is “target.” This shows that the target of the action “give” is the “book”. In addition, in the digraph illustrated in FIG. 1, there are arcs that have no endpoints. For example, from the node that represents “give,” the arcs to which the attributes “past” and “predicate” are given respectively extend. Such an arc that has no end point shows the role that a node has. For example, the arc to which the attribute “past” is given and which extends from the node that represents “give” shows that the action “give” was conducted in the past.

In addition, as illustrated in FIG. 1, the digraph is broken down into semantic minimum units.

The term “semantic minimum unit” is defined as the minimum partial structure of the semantic structure, and a group of three constituents, i.e., two nodes and an arc that connects the two nodes. The absence of a node may be represented as “NIL.”

Semantic minimum units are created as follows. First, arcs are extracted from a digraph.

In the case in which an arc connects two nodes, (the start point node from which the arc extends, the end point node toward which the arc is directed, the attribute that is given to the arc) are output to the arc as a semantic minimum unit. In the example illustrated in FIG. 1, for example, (GIVE, HANAKO, OBJECTIVE), (GIVE, TARO, AGENT), and (GIVE, BOOK, TATGET) fall into this case.

In the case in which there is no start point node from which an arc extends, (NIL, the end point node toward which the arc is directed, the attribute that is given to the arc) are output as a semantic minimum unit. In the example illustrated in FIG. 1, for example, (NIL, GIVE, CENTER) falls into this case.

In the case in which there is no endpoint node toward which an arc is directed, (the start point node from which the arc extends, NIL, the attribute that is given to the arc) are output as a semantic minimum unit. In the example illustrated in FIG. 1, for example, (GIVE, NIL, PREDICATE) and (GIVE, NIL, PAST) fall into this case.

Thus, a semantic minimum unit represents the relationship between two meanings in the original sentence or the role of a meaning. By searching a database while using semantic minimum units as retrieval keys, retrieval is made possible that reflects the intention of a person who searches for information, the intention being contained in a natural sentence.

In FIG. 2, a result is illustrated that is obtained by applying such processing to the case in which a retrieval query (referred to as an original sentence, or merely as a query) is “Relating to liver cancer, in which year and by which method were treatment results improved?” In this case, it is assumed that a correct document includes the phrase “treatment results of . . . cancer . . . .”

By analyzing the query, a digraph in which “improve”, “treatment result”, “year”, “cancer”, “liver”, etc., are nodes can be obtained. Concept symbols such as “IMPROVE”, “ABCXYZ”, “YEAR”, “CANCER”, “LIVER” are given to the nodes, respectively. An arc to which an attribute “OBJ (object)” is given is drawn from the node that represents “improve” to the node that represents “treatment result.” An arc to which an attribute “Time” is given is drawn from the node that represents “improve” to the node that represents “year.” An arc to which an attribute “MODIFY” is given is drawn from the node that represents “cancer” to the node that represents “liver.” Thus, by determining semantic minimum units that become retrieval keys from the semantic structure that is represented by such a digraph, (IMPROVE, CANCER, RELATE) and (IMPROVE, ABCXYZ, OBJ) can be obtained as illustrated in FIG. 2.

On the other hand, the semantic structure of the phrase “treatment results of . . . cancer . . . ” in the correct document is represented by a digraph in which an arc to which an attribute “MODIFY” is given is drawn from the node that represents “cancer” to the node that represents “treatment result.” By determining a semantic minimum unit that becomes a retrieval key from the digraph, (CANCER, ABCXYZ, MODIFY) is obtained as illustrated in FIG. 2.

Since a semantic minimum unit is based on a partial structure of a digraph, retrieval based on matching of semantic minimum units is more flexible than retrieval based on matching of digraphs. The inverse document frequency (IDF) value of a semantic minimum unit that is included in the document that is a retrieval target is prepared in advance, the IDF value of the matched minimum semantic unit is specified, and the evaluation value of the document that includes the sentence with respect to the matched minimum semantic unit can be calculated using the IDF value. The evaluation value of the document can be used for ranking.

Thus, a semantic analysis is performed on a query and each sentence that is included in a document that is a retrieval target, semantic minimum units of each of them are acquired, and retrieval can be performed using the semantic minimum units as retrieval keys. By using the IDF values of the semantic minimum units, the evaluation values of the extracted documents are calculated, and the documents can be ranked.

In information retrieval that uses perfect matching of semantic minimum units, in the case in which semantic minimum units in a natural sentence in a retrieval condition and those in a document in a database perfectly match, a high accuracy rate (precision) can be obtained.

As described above, in information retrieval that uses perfect matching of semantic minimum units, there may be a problem of retrieval omissions in which a semantic minimum unit does not match that in a document to be matched. In information retrieval, precision and recall are in a trade-off relationship. For example, if retrieval omission is prevented, that is, if recall is increased, precision decreases. For example, instead of retrieval based on semantic minimum units that are partial structures of the semantic structure obtained by analyzing a query, a retrieval key such as (semantic symbol 1, semantic symbol 2, *) and (semantic symbol 2, semantic symbol 1, *) (here, “*” is any arc that connects two semantic symbols) is created by combining two semantic signals that are included in the analysis result of the query, and the semantic structure in the database that matches the retrieval key is retrieved. As a result, recall improves greatly but precision decreases.

In general, in information retrieval that uses a semantic structure, precision and recall are in a trade-off relationship. Precision relates to an accuracy rate as to whether or not documents to be retrieved are retrieved. Recall relates to the degree of absence of retrieval omissions. For example, if retrieval omissions are prevented, that is, if recall is improved, precision decreases.

Hereinafter, an information retrieval device, an information retrieval method, and an information retrieval program that can prevent retrieval omissions while maintaining precision even in retrieval that uses a semantic structure will be described.

### <Outline>

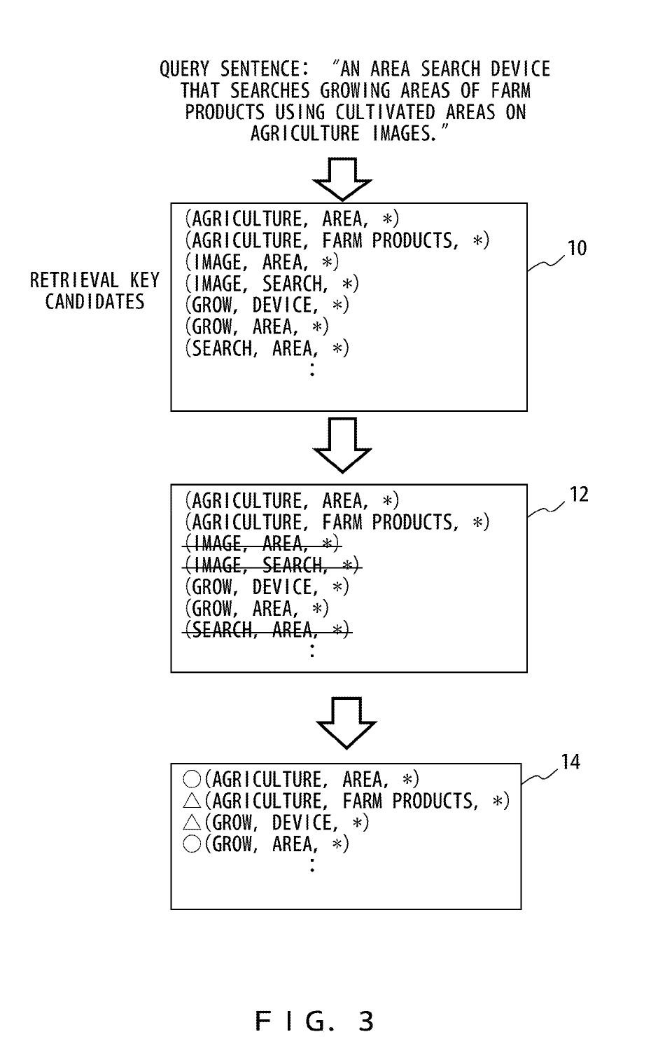

FIG. 3 is a diagram explaining an outline of a practical example that includes removal of the influence of retrieval keys that become noise and automatic determination of the noise.

In information retrieval that uses perfect matching of semantic minimum units, the cause of decreasing precision is that a lot of retrieval keys that become noise (that is, that match numerous documents, resulting in putting non-correct documents in higher ranks) are generated in retrieval keys. So as not to decrease precision, a highly accurate retrieval is made possible by using the following two processes.
(M1) Before retrieval, unnecessary combinations are removed using inverse document frequencies (IDF) and information on parts of speech of semantic symbols, and retrieval keys are created.
(M2) After retrieval, combinations that are likely to become noise are automatically determined.

In the above (M1), a combination that becomes noise means that the semantic symbols that constitute the combination match many documents. For example, a combination that becomes noise maybe defined as a combination that matches a lot of documents. Here, if combinations of specific parts of speech such as (noun, adverb, *) that are constituted of semantic symbols whose inverse document frequencies (IDF) are low are removed, noise is effectively removed before retrieval.

In the example illustrated in FIG. 3, “An area search device that searches growing areas of farm products using cultivated areas on agriculture images.” is input as a natural sentence query sentence.

The query sentence is semantically analyzed, and retrieval key candidates are created with combinations of optional semantic symbols (each of which represents the concept or the meaning of a word). As illustrated in retrieval key candidates 10 in FIG. 3, for example, (agriculture, area, *) (agriculture, farm products, *) (image, area, *) (image, search, *) (grow, device, *) (grow, area, *) (search, area, *) are created as the retrieval key candidates.

Next, in the same manner as in the above (M1), retrieval key candidates that become noise are removed from the retrieval key candidates 10 in FIG. 3, using inverse document frequencies (IDF) and information on parts of speech of the semantic symbols. The example of the result is illustrated in retrieval key candidates 12 after noise removal. In the example, (image, area, *) (image, search, *) (search, area, *) etc. are determined to be noise, and the retrieval key candidates are removed.

In the above (M2), retrieval is performed by a process other than (M1). As a retrieval key (combination) matches more documents, the retrieval key is more likely to be noise. Therefore, the number of matched documents is calculated for each combination, the combinations are sorted in descending order of the number of matched documents, and the combinations in the top n %, i.e., a predetermined ratio, are automatically determined to be the combinations that are likely to be noise (noise retrieval keys). As a result, combinations that match non-correct documents and that are remotely related to the original retrieval intention can be removed. A predetermined ratio (n %) may be any of 10%, 20%, 30%, or any other optional ratio.

In the example illustrated in FIG. 3, combinations are sorted in order of the number of matched documents from largest, and a result 14 is output in which “∘” (circle) is put on the combinations in the top n % and “Δ” (triangle) is put on the combinations other than those.

The combinations that are determined likely to be noise are removed, or weights thereof in retrieval are decreased, and therefore the evaluation value of each document is determined and each document is ranked.

In the following embodiments, information retrieval can be performed using a retrieval key that matches correct documents but does not often match documents other than those. If a retrieval key matches a lot of documents other than correct documents, the evaluation values of the non-correct documents are increased and the ranking orders of the correct documents are decreased. Such a situation can be avoided in the following embodiments. In the following embodiments, retrieval keys that will become noise are determined in two steps. Before retrieval, combinations that have parts of speech and attributes that are less likely to be effective as retrieval keys are deleted using IDF values or the like. At that time, a combination may be a combination of two parts of speech or a combination of two attributes. As a result of retrieval, weights in retrieval of combinations that match a lot of documents are decreased, and the evaluation value of each document is determined. Thus, the side effect of the retrieval keys becoming noise (the side effect of non-correct documents being high in ranking) can be prevented.

### <Information Retrieval Device>

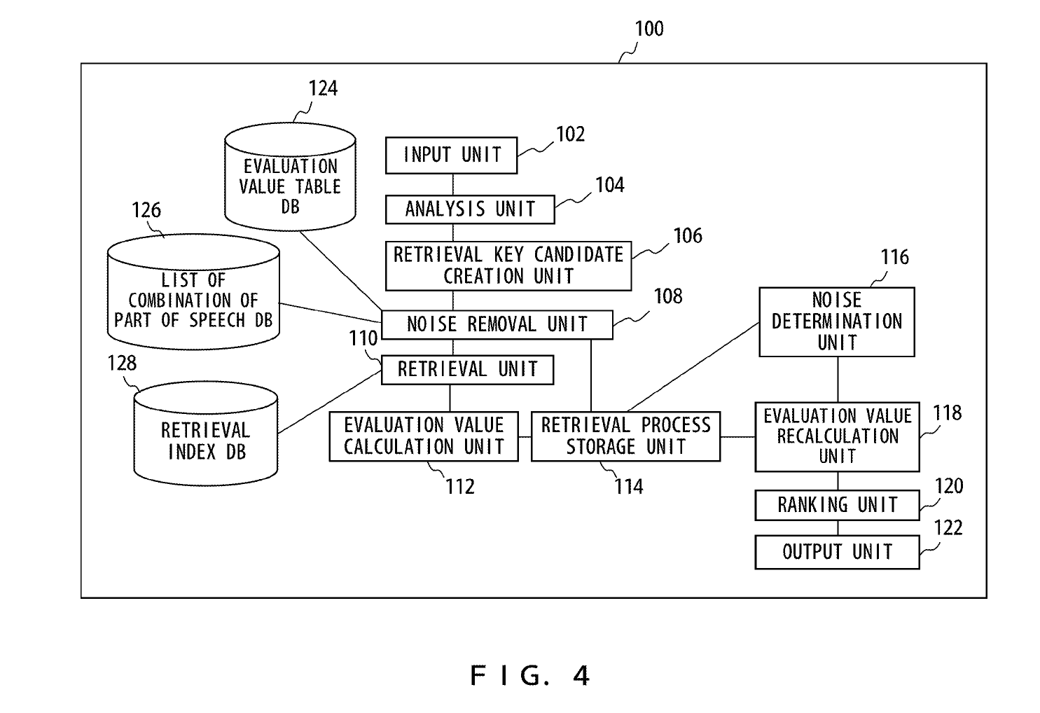

FIG. 4 is a diagram illustrating an example of a functional diagram of an information retrieval device 100 of a practical example.

The information retrieval device 100 includes an input unit 102, an analysis unit 104, a retrieval candidate creation unit 106, a noise removal unit 108, a retrieval unit 110, an evaluation value calculation unit 112, a retrieval process storage unit 114, a noise determination unit 116, an evaluation value recalculation unit 118, a ranking unit 120, and an output unit 122. The information retrieval device further includes an evaluation value table database (DB) 124 and a part-of-speech combination list database (DB) 126 that are linked with the noise removal unit 108, and a retrieval index database (DB) 128 that is linked with the retrieval unit 110.

The input unit 102 can input a query.

The analysis unit 104 can analyze the query, convert a word into a semantic symbol, and give information on a part of speech and a word attribute.

The retrieval key candidate creation unit 106 can create a retrieval key candidate by combining two semantic symbols.

The noise removal unit 108 refers to the evaluation value table database (DB) 124 that stores the IDF value of each semantic symbol, and the part-of-speech combination list database (DB) 126 that stores a list of parts of speech for determining a noise combination. Then, the noise removal unit 108 determines noise combinations, removes the noise combinations from the created retrieval candidates, and obtains retrieval keys.

The retrieval unit 110 can determine whether each retrieval key that is output by the noise removal unit 108 matches a semantic structure in a database.

The evaluation value calculation unit 112 can calculate a document evaluation value on the basis of the weight of the matched retrieval key with respect to each document.

The retrieval process storage unit 114 can store a retrieval key, its weight, and documents that match the retrieval key.

The noise determination unit 116 can automatically determine a retrieval key (noise retrieval key) that becomes noise from the retrieval processing process of the retrieval process storage unit 114.

The evaluation value recalculation unit 118 can recalculate the document evaluation value of a document that matches the retrieval key (noise retrieval key) that is determined to be noise by the noise determination unit 116, on the basis of the retrieval process that is stored in the retrieval process storage unit 114.

The ranking unit 120 can sort documents in order of document evaluation values that are calculated by the evaluation value recalculation unit 118.

The output unit 122 can output the result obtained by the ranking unit 120.

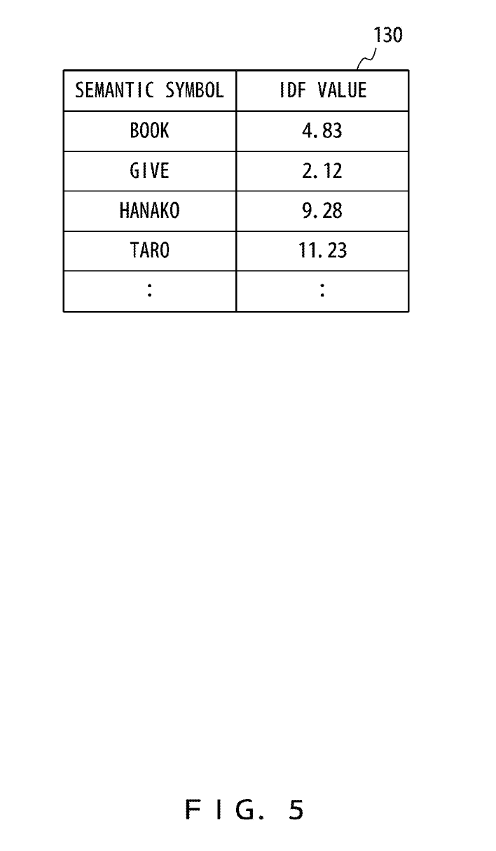

FIG. 5 is a diagram illustrating an example of data that are stored in an evaluation value table 130 in the evaluation value table DB 124. In the evaluation value table 130, the IDF value of each semantic symbol is stored. For example, in the example illustrated in FIG. 5, the IDF value of the semantic symbol “BOOK” is “4.83” and the IDF value of the semantic symbol “GIVE” is “2.12.”

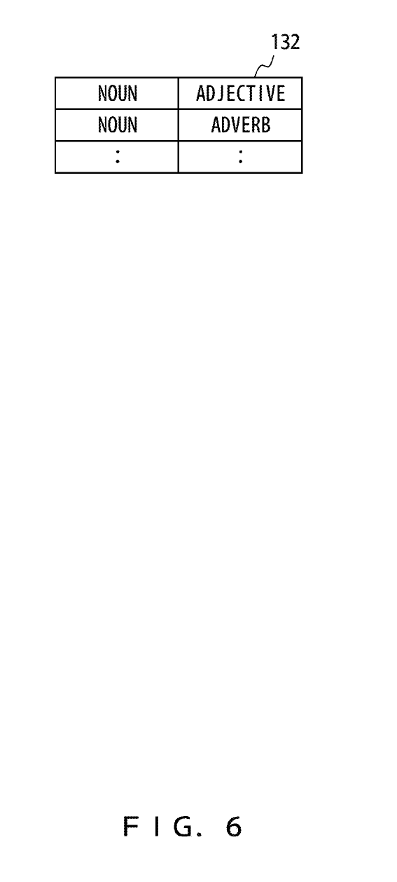

FIG. 6 is a diagram illustrating an example of data that is stored in a list 132 of combinations of parts of speech in the part-of-speech combination list database (DB) 126. The list 132 of combinations of parts of speech that is stored in the part-of-speech combination list database (DB) 126 is referred to in a step of removing unnecessary combinations by using inverse document frequencies (IDF) and information on parts of speech of semantic symbols before retrieval in the above (M1). Combinations of (noun, adjective, *) and (noun, adverb, *) are illustrated in FIG. 6: however; other combinations can be included as described above.

The input unit 102 receives a retrieval query of a natural sentence (natural language sentence). The retrieval query may be input by a user of the information retrieval device 100.

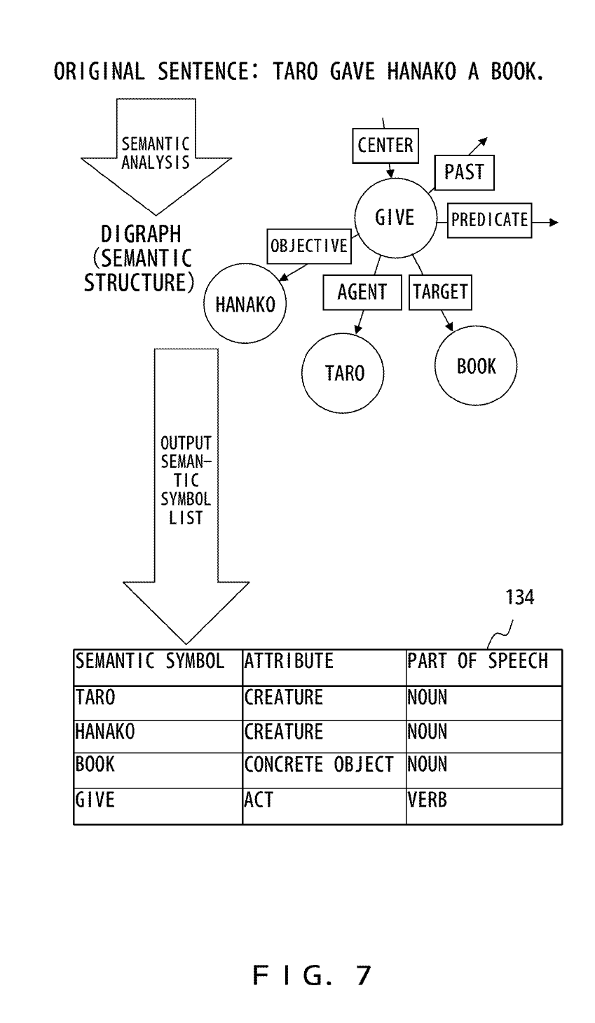

FIG. 7 is a diagram explaining an outline of a semantic analysis.

In the example illustrated in FIG. 7, a natural sentence “Taro gave Hanako a book.” is input to the input unit 102 as a retrieval query (original sentence).

The analysis unit 104 executes a semantic analysis of the retrieval query that is received by the input unit 102.

The analysis unit 104 executes a morphological analysis and the semantic analysis. The morphological analysis divides an input sentence into words. The semantic analysis is a technique for analyzing a semantic relationship of each word by using the morphological analysis result and grammar rules, is an existing technique, and outputs the semantic structure that is illustrated on the right in the FIG.7. A node of the semantic structure corresponds to the semantic symbol of the morphological analysis result.

Similarly to the case in which the word “using” is analyzed as the verb “use” (semantic symbol: USE) in a morphological analysis, but is analyzed as an arc that represents a tool instead of a node in a semantic structure, there are cases in which the semantic symbol of the morphological analysis result is not necessarily used as it is in the semantic analysis. Therefore, both morphological analysis and semantic analysis are executed in the embodiments; however, only the morphological analysis may be executed while extracting semantic symbols.

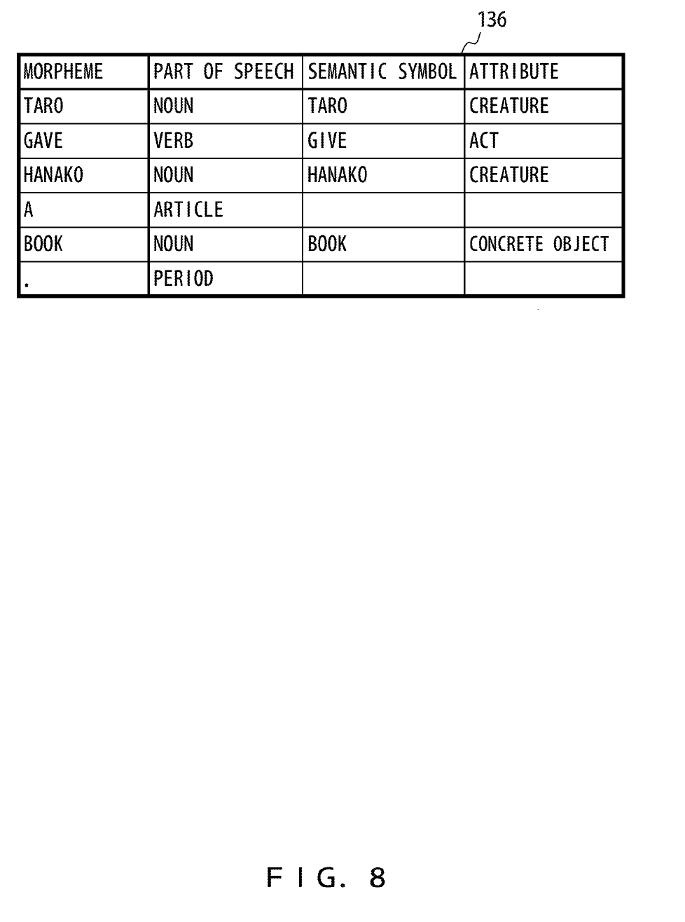

FIG. 8 is a diagram illustrating one example of the result of a morphological analysis.

In FIG. 8, a natural sentence “Taro gave Hanako a book.” is broken down into morphemes such as “Taro” “gave” “Hanako” “a” and “book.” Then, in the example illustrated in FIG. 8, a part of speech, a semantic symbol, and an attribute are given to each morpheme by a semantic analysis. A part of speech, a semantic symbol, and an attribute given to each morpheme may be merely referred to as characteristics. For example, to the morpheme “Taro”, “noun” as a part of speech, “TARO” as a semantic symbol, and “creature” as an attribute are given. To the morpheme “gave”, “verb” as apart of speech, “GIVE” as a semantic symbol, and “action” as an attribute are given. To each of the other morphemes “Hanako” “a” and “book, ” apart of speech, a semantic symbol, and an attribute are given. Other examples of the attributes may include an abstract entity and an action.

The analysis unit 104 obtains a digraph such as that illustrated in FIG. 7. The analysis unit 104 outputs a semantic symbol list 134 as illustrated in FIG. 7.

The retrieval key candidate creation unit 106 creates all the combinations of the semantic symbols by referring to the semantic symbol list.

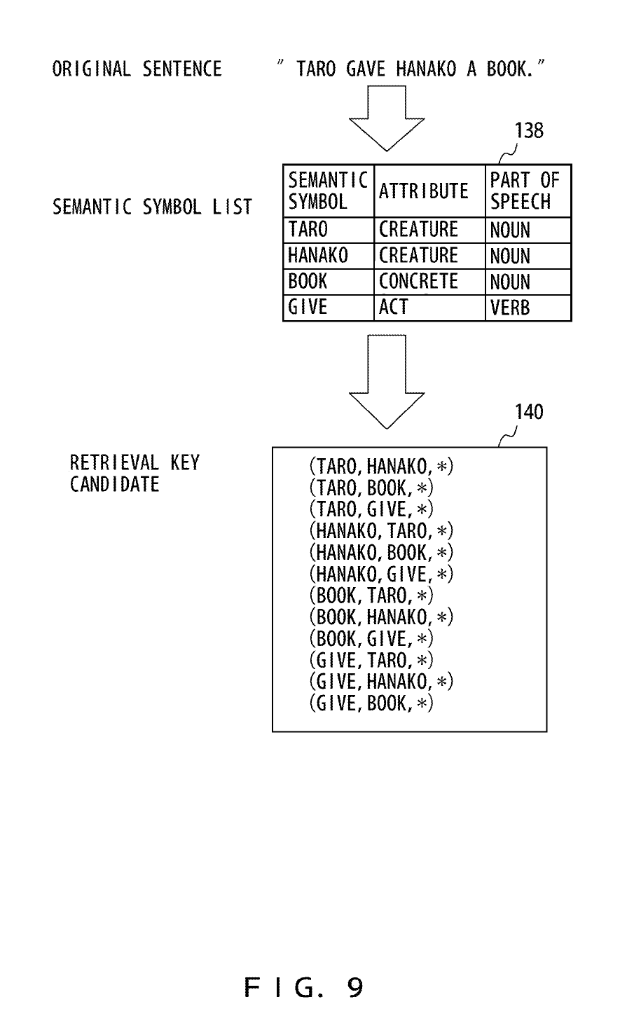

FIG. 9 is a diagram explaining an outline of retrieval key creation.

In the case in which “Taro gave Hanako a book.” is input as the original sentence to the input unit 102, and a semantic symbol list 138 that includes four semantic symbols of “TARO” “HANAKO” “BOOK” and “GIVE” as the semantic symbols is created in the analysis unit 104, the retrieval key creation unit 106 creates all the combinations of the four semantic symbols such as (TARO, HANAKO, *) and (TARO, BOOK, *) as retrieval key candidates 140.

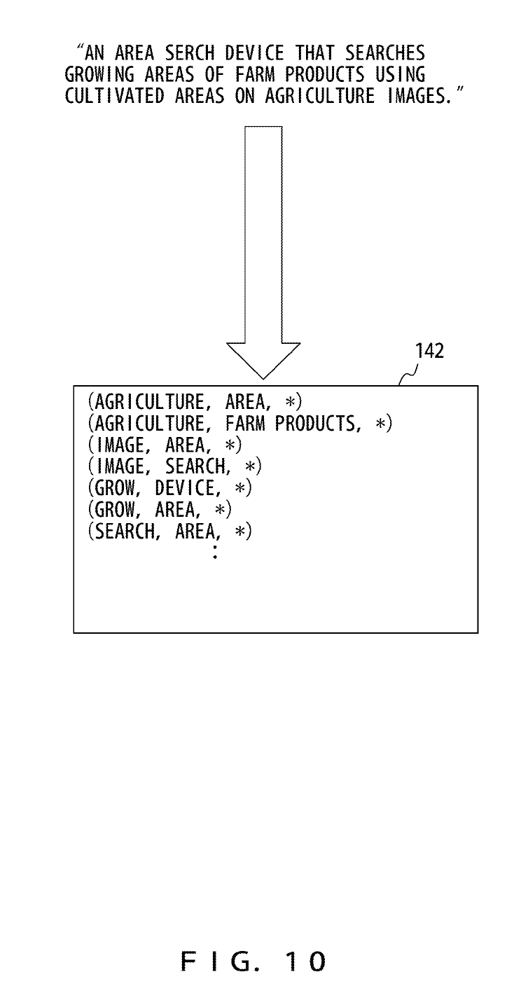

FIG. 10 is a diagram illustrating examples of retrieval keys. In this example, retrieval key candidates 142 are shown that are created by the retrieval key candidate creation unit 106 when “An area search device that searches growing areas of farm products using cultivated areas on agriculture images.” is input to the input unit 102.

For example, if the analysis unit 104 performs a morphological analysis and a semantic analysis on the sentence “An area search device that searches growing areas of farm products using cultivated areas on agriculture images,” semantic symbols such as “AGRICULTURE” “IMAGE” “AREA” “FARM PRODUCTS” “GROW” “SEARCH” and “DEVICE” are created. The retrieval key candidate creation unit 106 creates all the combinations of the semantic symbols as retrieval key candidates. The retrieval candidates can include, for example, as illustrated in table 142 in FIG. 10, (AGRICULTURE, AREA, *) (AGRICULTURE, FARM PRODUCTS, *) (IMAGE, AREA, *) (IMAGE, SEARCH, *) (GROW, DEVICE, *) (GROW, AREA, *) and (SEARCH, AREA, *).

The noise removal unit 108 removes unnecessary combinations by using the IDF values and information on parts of speech of the semantic symbols from the retrieval key candidates that are created by the retrieval key candidate creation unit 106, and creates retrieval keys.

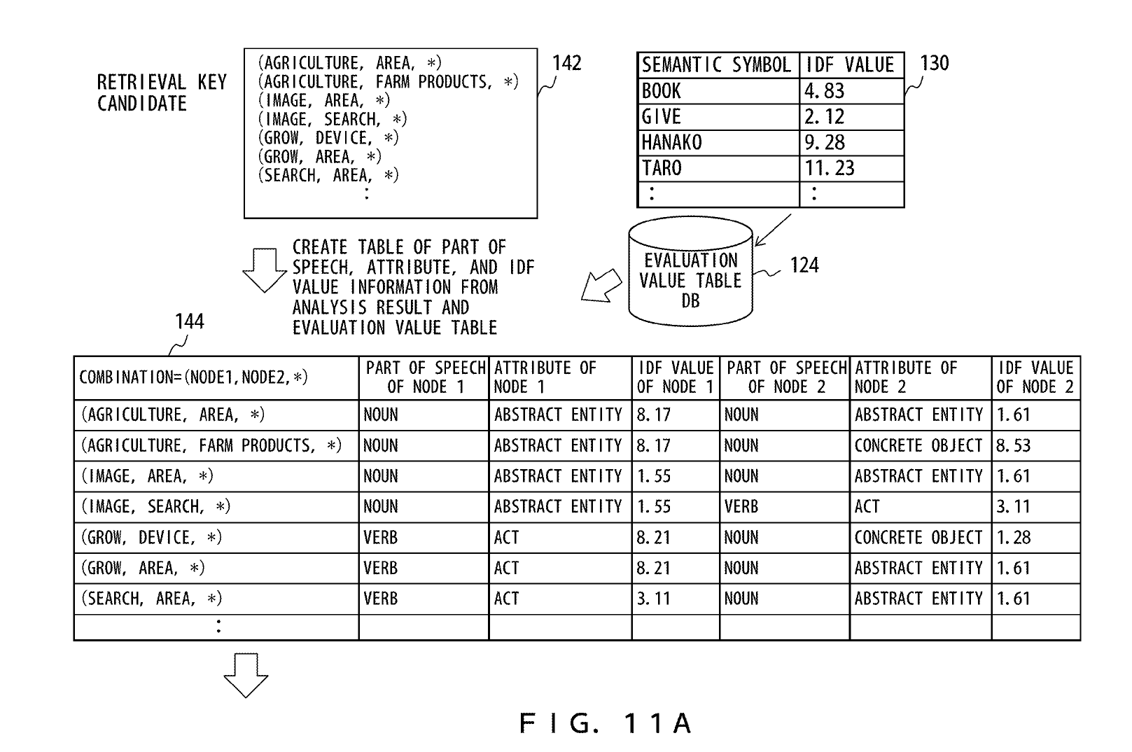

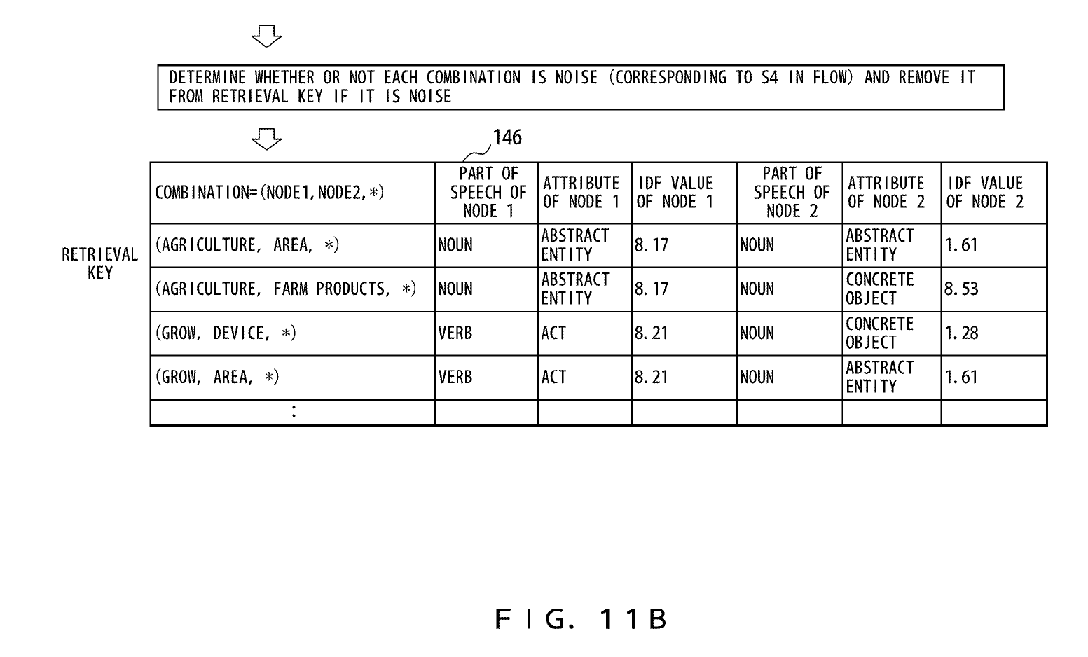

FIGS. 11A and 11B are a diagram explaining an outline of removal of the influences of the retrieval keys that become noise.

As illustrated in FIGS. 11A and 11B, with respect to the combinations of the retrieval key candidates 142, the noise removal unit 108 extracts the parts of speech and the attributes of the analysis result by referring to the evaluation value table DB 142, extracts information on the IDF values from the evaluation value table 130, and creates a table 144. In the example of the table 144 illustrated in FIGS. 11A and 11B, to a combination (NODE 1, NODE 2, *), the part of speech of NODE 1, the attribute of NODE 1, the IDF value of NODE 1, the part of speech of NODE 2, the attribute of NODE 2, and the IDF value of the NODE 2 are given. For example, with respect to (AGRICULTURE, AREA, *) as one of the retrieval candidates, the part of speech of NODE 1 can be “noun,” the attribute of NODE 1 can be “abstract entity,” the IDF value of NODE 1 can be “8.17,” the part of speech of NODE 2 can be “noun,” the attribute of NODE 2 can be “abstract entity,” and the IDF value of NODE 2 can be “1.61.”

The noise removal unit 108 determines whether or not each combination is noise by using some or all of the part of speech, attribute, and IDF value of each semantic signal, and if the combination is determined to be noise, deletes it from the retrieval key candidates. Then, the noise removal unit 108 creates retrieval keys 146 obtained by removing the combinations that are determined to be noise from the retrieval key candidates.

The combinations that are determined to be noise can be removed from the retrieval key candidates by using, for example, the parts of speech of the semantic symbols. Assuming that a retrieval key candidate is (Node 1, Node 2, *), the examples of the combinations of the parts of speech to be removed can include the following:
The part of speech of Node 1 or Node 2 is an auxiliary verb (“can” etc.);
The part of speech of Node 1 or Node 2 is an adverb;
The parts of speech of both Node 1 and Node 2 are auxiliary verbs;
The parts of speech of both Node 1 and Node 2 are adverbs;
The parts of speech of both Node 1 and Node 2 are adjectives;
The part of speech of one node is an adverb, and the part of speech of the other node is a noun;
The part of speech of one node is an adverb, and the part of speech of the other node is an adjective; and
The part of speech of one node is an adjective, and the part of speech of the other node is a verb.

The combinations that are determined to be noise may be removed from the retrieval key candidates by using IDF values.
The IDF value of Node 1 or Node 2 is not more than a predetermined value (for example, 1.2).
Both the IDF values of Node 1 and Node 2 are not more than a predetermined value (for example, 2.5).
The attribute of Node 1 or Node 2 is an action, and the attribute of the other is an action.

In addition, the combinations that are determined to be noise may be removed from the retrieval key candidates by using combinations of both parts of speech and IDF values. The part of speech of Node 1 is a noun and the IDF value thereof is not more than a first value (for example, 2.5), and the part of speech of Node 2 is a verb and the IDF value thereof is not more than a second value (for example, 4). The examples of the retrieval keys that are created in the above-described manner are illustrated in FIGS. 11A and 11B. In FIGS. 11A and 11B, (IMAGE, AREA, *) (IMAGE, SEARCH, *) etc. are determined to be noise and are deleted. (IMAGE, AREA, *) falls into the case in which both the IDF values of Node 1 and Node 2 are not more than a predetermined value (for example, 2.5), and (IMAGE, SEARCH, *) falls into the case in which “the part of speech of Node 1 is a noun and the IDF value thereof is not more than a first value (for example, 2.5), and the part of speech of Node 2 is a verb and the IDF value thereof is not more than a second value (for example, 4).”

Then, the noise removal unit 108 creates as retrieval keys, (AGRICULTURE, AREA, *) (AGRICULTURE, FARM PRODUCTS, *) (GROW, DEVICE, *) (GROW, AREA, *), etc.

The retrieval unit 110 determines whether or not each retrieval key output by the noise removal unit 108 matches the semantic structure that is stored in the retrieval index database (DB) 128.

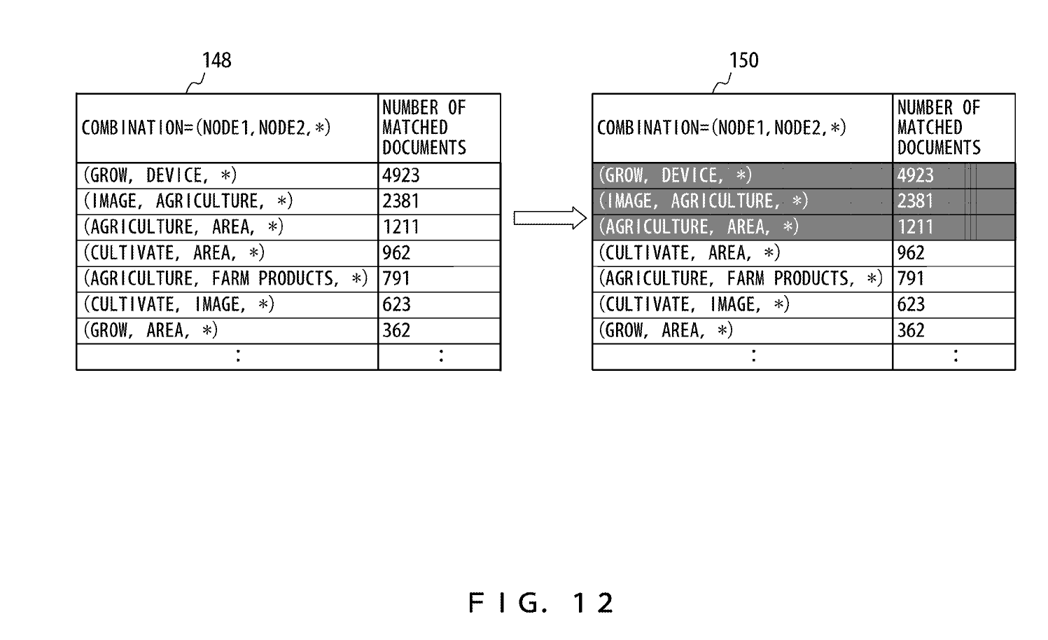

The retrieval unit 110 executes retrieval, and calculates how many documents are matched to each retrieval key. The result is, for example, illustrated in table 148 in FIG. 12. In table 148, the number of matched documents (“the number of matched documents” in the table) with respect to each retrieval key is shown.

The evaluation value calculation unit 112 can calculate the document evaluation value with respect to each document, on the basis of the weight of the matched retrieval key. The weight of each combination is calculated, and the weight of the combination is added as the evaluation value to the document that matches the combination. The weight of each combination of the retrieval key is calculated on the basis of the IDF value of each semantic symbol, and on the basis of the appearance frequency in the query and information on the part of speech, etc. of the semantic symbol.

For example, the weight of the combination (NODE 1, NODE 2, *) may be defined as the sum of the product of the IDF value of NODE 1 and the appearance frequency of NODE 1, and the product of the IDF value of NODE 2 and the appearance frequency of NODE 2, that is, “the IDF value of NODE 1×the appearance frequency of NODE 1+the IDF value of NODE 2×the appearance frequency of NODE 2.”

The retrieval process storage unit 114 stores all of the combinations that become retrieval keys, the weights of the combinations, and information (for example, document ID) for specifying the document that matches the combination. Such information can be used in the noise determination unit 116 and the evaluation value recalculation unit 118.

The noise determination unit 116 sorts retrieval keys in descending order of the number of matched documents with respect to each retrieval key, and determines as noise the retrieval keys that are ranked in the top n %. A document that is determined to be noise may be referred to as a noise document.

FIG. 12 is a diagram explaining an outline of the automatic determination of noise.

In table 148 in FIG. 12, it is assumed that 32 combinations of retrieval keys such as (GROW, DEVICE, *), (IMAGE, AGRICULTURE, *) are held. As shown in the boxes with black backgrounds in table 150, retrieval keys that are ranked in the top 10% of the 32 combinations, that is, the three retrieval keys from the top, are determined to be noise (noise retrieval keys).

The evaluation value recalculation unit 118 recalculates the evaluation value of the document that matches the combination that is determined to be noise. The evaluation value recalculation unit 118 deducts the value calculated from the weight of each combination from the evaluation value of the matched document. Here, the “value calculated from the weight of a combination” may be the weight of the combination itself. When the combination is automatically determined to be noise, the value maybe the weight of the combination itself in the case in which the combination is ranked in the top h %, and the value may be the weight of the combination×0.5 etc. in the case in which the combination is ranked lower than the top h %.

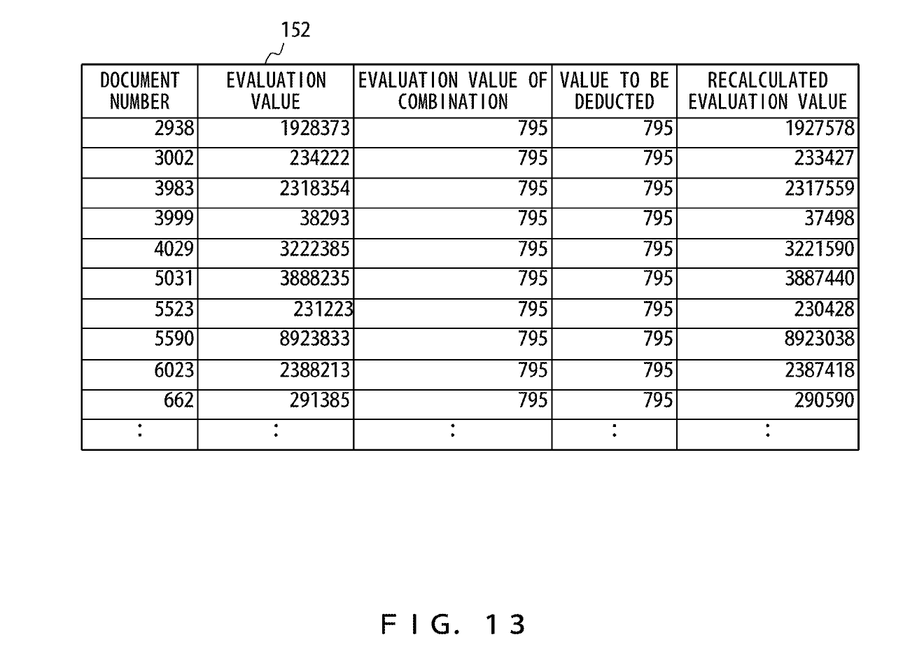

FIG. 13 is a diagram explaining recalculation of the evaluation value of a document.

In table 152 in FIG. 13, the evaluation values of the documents that match (GROW, DEVICE, *) and their recalculated evaluation values are shown. In table 152, a case is illustrated in which the weight of (GROW, DEVICE, *) is 795, and the deducted value is the weight itself of (GROW, DEVICE, *). Such recalculation is performed on all the combinations that are determined to be noise, and the final evaluation values of the documents are calculated.

The ranking unit 120 sorts the documents in order of the document evaluation values (for example, the values that are in the column “recalculated evaluation value” in table 152 in FIG. 13) that are calculated by the evaluation value recalculation unit 118.

The output unit 122 can output the result that is obtained by the ranking unit 120. For example, the effect of increasing the rate of correct documents that are ranked in the top 200 is obtained.

The retrieval candidate creation unit 106 and the noise reduction unit 108 may be combined so as to form a retrieval key creation unit that breaks down a natural sentence into a plurality of words, and creates a retrieval key from retrieval key candidates which each include two words out of the plurality of words on the basis of characteristics that are given to each of the two words.

The retrieval key creation unit breaks down a natural sentence into a plurality of words, and creates a retrieval key from retrieval key candidates which each include two words out of the plurality of words on the basis of characteristics that are given to each of the two words.

The retrieval unit 110 specifies the documents that include the retrieval key, and calculates the evaluation values of the specified documents and the number of specified documents. The retrieval unit 110 may calculate the evaluation value of the document that corresponds to the retrieval key by using the weight that is calculated using at least either the characteristics of two words that are included in the retrieval key or the appearance frequency in the natural sentence of the words included in the retrieval key, the weight corresponding to the words.

The evaluation value recalculation unit 118 recalculates the evaluation value of the document that corresponds to the retrieval key that is determined to be noise, on the basis of the number of specified documents.

The output unit 122 outputs the documents on the basis of the recalculated evaluation values.

Thus, in the information retrieval device 100, combinations of semantic symbols that correspond to morphemes in a query are made to be retrieval keys, noise is automatically determined in the combinations, and retrieval is realized that is higher in recall than that in a conventional art while maintaining a high precision. In addition, in the information retrieval device 100, even in retrieval that uses a semantic structure, retrieval omissions can be prevented while maintaining precision.

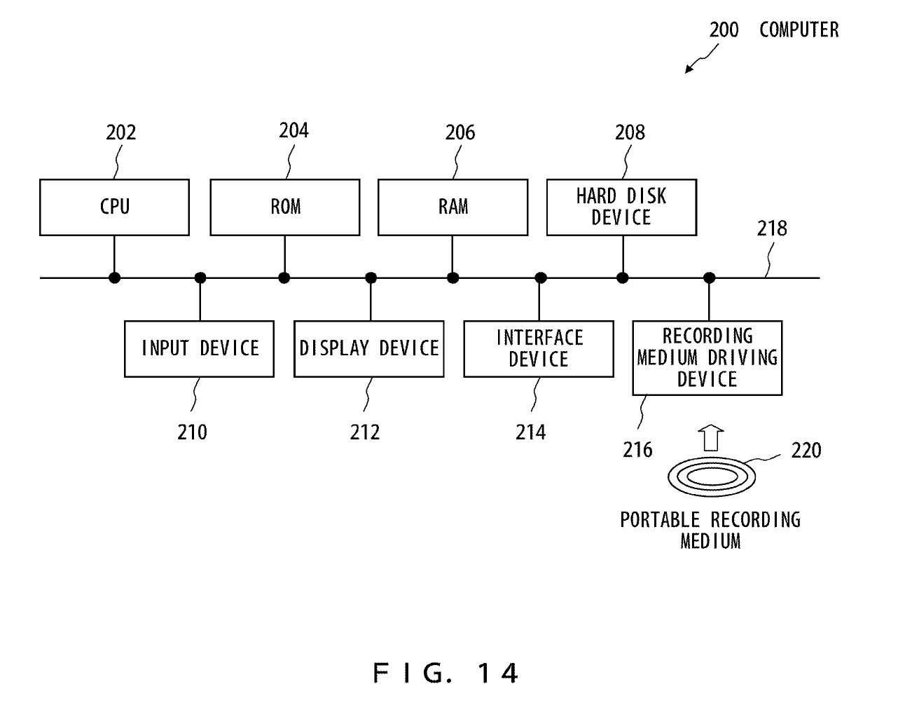

FIG. 14 is a diagram illustrating an example of the configuration of the information retrieval device 100 of the embodiments.

A computer 200 includes a Central Processing Unit (CPU) 202, a Read Only Memory (ROM) 204, and a Random Access Memory (RAM) 206. The computer 200 further includes a hard disk device 208, an input device 210, a display device 212, an interface device 214, and a recording medium driving device 216. These constituents are connected to one another through a bus line 220, and can transmit and receive various data to and from one another under control of the CPU 202.

The Central Processing Unit (CPU) 202 is an arithmetic processing unit that controls all of the operations of the computer 200, and functions as a control processing unit of the computer 200.

The Read Only Memory (ROM) 204 is a read-only semiconductor memory in which a predetermined basic control program is recorded in advance. By reading out and executing the basic control program at the start-up of the computer 100, the CPU 202 can control the operation of each of the constituents of the computer 200.

The Random Access Memory (RAM) 206 is an always readable and writeable semiconductor memory that the CPU 202 uses as a working storage area as necessary, when the CPU executes various control programs.

The hard disk device 208 is a storage device that stores various control programs that are executed by the CPU 202 and various data. By reading out and executing a predetermined control program that is stored in the hard disk device 208, the CPU 202 can execute various types of control processing that will be described hereinafter.

The input device 210 is for example a mouse device or a keyboard device. When operated by a user, the input device acquires an input of various pieces of information that are associated with the operation content, and sends the acquired input information to the CPU 202.

The display device 212 is, for example, a liquid crystal display, and displays various texts and images in response to display data that is sent by the CPU 202.

The interface device 214 manages a transfer of various pieces of information between itself and various pieces of equipment connected to the computer 200.

The recording medium driving device 216 is a device that reads out various control programs and data that are recorded in a portable recording medium 218. The CPU 202 can execute various types of control processing that will be described hereinafter by reading out and executing, through the recording medium driving device 216, the predetermined control program that is recorded in the portable recording medium 218. The examples of the portable recording medium 218 include a flash memory that includes a USB (Universal Serial Bus) standard connector, a CD-ROM (Compact Disc Read Only Memory), and a DVD-ROM (Digital Versatile Disc Read Only Memory).

In order to constitute the information retrieval device 100 by using the above-described computer 200, for example, a control program for causing the CPU 202 to execute processing in each of the above processing units is created. The created control program is stored in advance in the hard disk device 208 or the portable recording medium 218. Then, predetermined instructions are given to the CPU 202, and the control program is read out and executed by the CPU 202. Thus, the functions that are included in the information retrieval device 100 are provided by the CPU 202.

### <Information Retrieval Processing>

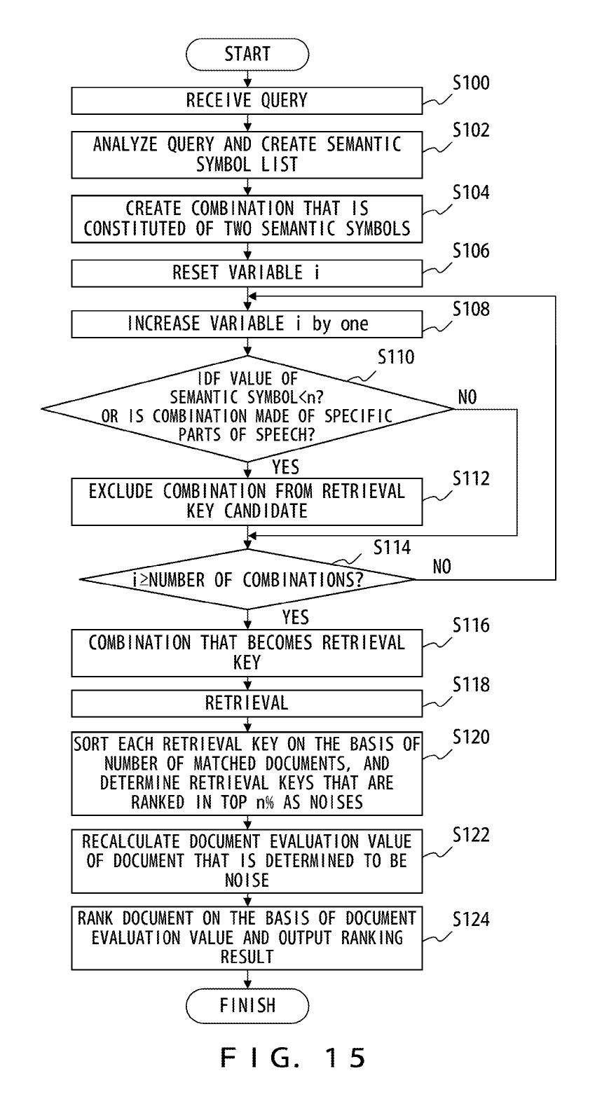

Information retrieval processing will be described with reference to FIG. 15.

If the information retrieval device 100 is the general-purpose computer 200 as illustrated in FIG. 14, the following description defines a control program that executes such processing. That is, the following description is a description for the control program that causes the general-purpose computer to execute the processing that will be described hereinafter.

When the processing is initiated, the input unit 102 receives a query in S100. For example, as described in relation to FIG. 10, the query may be “An area search device that searches growing areas of farm products using cultivated areas on agriculture images.”

In the next S102, the analysis unit 104 analyses the query, and creates a semantic symbol list. When the query is “An area search device that searches growing areas of farm products using cultivated areas on agriculture images,” the semantic symbol list can include “AGRICULTURE,” “IMAGE,” “AREA,” “FARM PRODUCTS,” “GROW,” “SEARCH,” “DEVICE,” etc.

Next, in S104, the retrieval key candidate creation unit 106 creates a combination that is constituted of two semantic symbols as a retrieval key candidate. When the query is “An area search device that searches growing areas of farm products using cultivated areas on agriculture images,” as illustrated in table 142 in FIG. 10, the examples of the retrieval key candidates can include (AGRICULTURE, AREA, *) (AGRICULTURE, FARM PRODUCTS, *) (IMAGE, AREA, *) (IMAGE, SEARCH, *) (GROW, DEVICE, *) (GROW, AREA, *) and (SEARCH, AREA, *).

In the next S106, the noise removal unit 108 resets a variable i. For example, i=0 is possible. The variable i is a variable that specifies the combination (retrieval key candidate) that is created in S104.

In the next S108, the noise removal unit 108 increases the variable i by 1.

In the next S110, the noise removal unit 108 determines with respect to the combination that corresponds to the current variable i, whether or not the IDF value of the semantic symbol is smaller than a predetermined number n, or whether or not the combination is a combination of specific parts of speech. Conditions may be related to some or all of the parts of speech, attribute, and IDF value of each semantic symbol, with respect to the combination that corresponds to the current variable i. For example, the following conditions can be included.
The part of speech of Node 1 or Node 2 is an auxiliary verb (“can” etc.).
The part of speech of Node 1 or Node 2 is an adverb.
The parts of speech of both Node 1 and Node 2 are auxiliary verbs.
The parts of speech of both Node 1 and Node 2 are adverbs.
The parts of speech of both Node 1 and Node 2 are adjectives.
The part of speech of one node is an adverb, and the part of speech of the other node is a noun.
The part of speech of one node is an adverb, and the part of speech of the other node is an adjective.
The part of speech of one node is an adjective, and the part of speech of the other node is a verb.
The IDF value of Node 1 or Node 2 is not more than a predetermined value (for example, 1.2).
Both the IDF values of Node 1 and Node 2 are not more than a predetermined value (for example, 2.5).
The attribute of Node 1 or Node 2 is an action, and the attribute of the other is an action.
The part of speech of Node 1 is a noun and the IDF value thereof is not more than a first value (for example, 2.5), and the part of speech of Node 2 is a verb and the IDF value thereof is not more than a second value (for example, 4).

When the result of determination in S110 is “YES,” that is, with respect to the combination that corresponds to the current variable i, when the IDF value of the semantic symbol is smaller than the predetermined number n, or the combination is a combination of specific parts of speech, processing proceeds to S112. When the result of determination in S110 is “NO,” that is, with respect to the combination that corresponds to the current variable i, when the IDF value of the semantic symbol is not smaller than the predetermined number n, and the combination is not a combination of the specific parts of speech, processing proceeds to S114.

In S112, the noise removal unit 108 excludes the combination selected in S110 from the retrieval key candidates. For example, as illustrated in FIGS. 11A and 11B, the noise removal unit 108 creates retrieval keys 146 obtained by removing noise from the retrieval key candidates.

In S114, the noise removal unit 108 determines whether or not the current variable i is not less than the number of combinations, that is, the number of retrieval key candidates. If the determination result is “YES”, that is, that the current variable i is not less than the number of combinations, processing proceeds to S116. If the determination result is “NO”, that is, that the current variable i is less than the number of combinations, processing returns to S108.

In S116, the noise removal unit 108 creates combinations that become retrieval keys. When the processing in this step is terminated, processing proceeds to S118.

In S118, the retrieval unit 110 executes retrieval, and calculates how many documents match each retrieval key. The result is illustrated, for example, in table 148 in FIG. 12. In addition, in 5118, the evaluation value calculation unit 112 can calculate the document evaluation value with respect to each document on the basis of the weight of the matched retrieval key. The weight is calculated with respect to each combination, and the weight of the combination is added as the evaluation value to the document that matches the combination. The weight of each combination of the retrieval key is calculated on the basis of the IDF value of each semantic symbol, and on the basis of the appearance frequency of the semantic symbol in the query and information on the part of speech, etc. For example, the weight of the combination (NODE 1, NODE 2, *) may be defined as the sum of the product of the IDF value of NODE 1 and the appearance frequency of NODE 1, and the product of the IDF value of NODE 2 and the appearance frequency of NODE 2, that is, “the IDF value of NODE 1×the appearance frequency of NODE 1+the IDF value of NODE 2×the appearance frequency of NODE 2.”

In S118, the retrieval process storage unit 114 stores all of the combinations that become retrieval keys, the weights of the combinations, and information (for example, document ID) for specifying the document that matches the combination. Such information can be used in the noise determination unit 116 and the evaluation value recalculation unit 118. When the processing in this step is terminated, processing proceeds to S120.

In S120, the noise determination unit 116 sorts retrieval keys in descending order of the number of matched documents with respect to each retrieval key, and determines as noise the retrieval keys that are ranked in the top n %. As shown in the boxes with black backgrounds in table 150, the retrieval keys that are ranked in the top 10% of the 32 combinations, that is, the three retrieval keys from the top are determined to be noise. When the processing in this step is terminated, processing proceeds to S122.

In S122, the evaluation value recalculation unit 118 recalculates the evaluation value of the document that matches the combination that is determined to be noise. In table 152 in FIG. 13, the evaluation values of the documents that match (GROW, DEVICE, *) and their recalculated evaluation values are shown. When the processing in this step is terminated, processing proceeds to S124.

In S124, the ranking unit 120 sorts the documents in order of the document evaluation values (for example, the values filled in in the column “recalculated evaluation value” in table 152 in FIG. 13) that are calculated by the evaluation value recalculation unit 118. In S124, the output unit 122 outputs the result obtained by the ranking unit 120.

Thus, combinations of semantic symbols that correspond to the morphemes in a query are made to be retrieval keys. By automatically determining noise from the combinations, retrieval can be realized with a higher recall than that in the conventional technique while maintaining high precision. Even in retrieval that uses the semantic structure, retrieval omissions can be prevented while maintaining precision.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information retrieval device comprising:
a processor configured to execute processing including:
breaking down a natural sentence into a plurality of words, and creating retrieval keys from retrieval key candidates which each include two words out of the plurality of words, on the basis of characteristics that are given to each of the two words;
specifying documents that include the retrieval keys, and calculating evaluation values of the specified documents and a number of specified documents;
recalculating the evaluation values of the documents that correspond to the retrieval keys that are determined to be noise, on the basis of the number of specified documents; and
outputting the documents on the basis of the recalculated evaluation values.

2. The information retrieval device according to claim 1, wherein
the calculating calculates the evaluation value of the document that corresponds to the retrieval key, by using a weight that is calculated using at least either the characteristics of the two words that are included in the retrieval key or an appearance frequency in a natural sentence of the words that are included in the retrieval key, the weight corresponding to the words.

3. The information retrieval device according to claim 1, wherein,
the characteristics of the word include apart of speech, an attribute, and an inverse document frequency.

4. The information retrieval device according to claim 3, wherein
the creating creates the retrieval key from the retrieval key candidates, on the basis of conditions related to the part of speech, the attribute, and a size of the inverse document frequency, with respect to each of the two words.

5. The information retrieval device according to claim 1, wherein
the retrieval key candidate is formed of semantic symbols that are symbols obtained by executing a semantic analysis with respect to the two words.

6. An information retrieval method that is executed by a computer, the information retrieval method comprising:
breaking down a natural sentence into a plurality of words, and creating retrieval keys from retrieval key candidates which each include two words out of the plurality of words, on the basis of characteristics that are given to each of the two words by using the computer;
specifying documents that include the retrieval keys, and calculating evaluation values of the specified documents and a number of the specified documents by using the computer;
recalculating the evaluation values of the documents that correspond to the retrieval keys that are determined to be noise, on the basis of the number of specified documents by using the computer; and
outputting the documents on the basis of the recalculated evaluation values by using the computer.

7. The information retrieval method according to claim 6, wherein
the calculating calculates the evaluation value of the document that corresponds to the retrieval key, by using a weight that is calculated using at least either the characteristics of two words that are included in the retrieval key or an appearance frequency in a natural sentence of the words that are included in the retrieval key, the weight corresponding to the words.

8. The information retrieval method according to claim 6, wherein
the characteristics of the word include apart of speech, an attribute, and an inverse document frequency.

9. The information retrieval method according to claim 8, wherein
the creating creates the retrieval key from the retrieval key candidates, on the basis of conditions related to the part of speech, the attribute, and a size of the inverse document frequency, with respect to each of the two words.

10. The information retrieval method according to claim 6, wherein
the retrieval key candidate is formed of semantic symbols that are symbols obtained by executing a semantic analysis with respect to the two words.

11. A computer-readable recording medium having stored therein a program for causing a computer to execute a process for retrieving information, the process comprising:
breaking down a natural sentence into a plurality of words, and creating retrieval keys from retrieval key candidates which each include two words out of the plurality of words, on the basis of characteristics that are given to each of the two words;
specifying documents that include the retrieval keys, and calculating evaluation values of the specified documents and a number of the specified documents;
recalculating the evaluation values of the documents that correspond to the retrieval keys that are determined to be noise, on the basis of the number of specified documents; and
outputting the documents on the basis of the recalculated evaluation values.

12. The non-transitory computer readable recording medium according to claim 11, wherein
the calculating calculates the evaluation value of the document that corresponds to the retrieval key, by using a weight that is calculated using at least either the characteristics of the two words that are included in the retrieval key or an appearance frequency in a natural sentence of the words included in the retrieval key, the weight corresponding to the words.

13. The non-transitory computer readable recording medium according to claim 11, wherein
the characteristics of the word include apart of speech, an attribute, and an inverse document frequency.

14. The non-transitory computer readable recording medium according to claim 13, wherein
the creating creates the retrieval key from the retrieval key candidates, on the basis of conditions related to the part of speech, the attribute, and a size of the inverse document frequency, with respect to each of the two words.

15. The non-transitory computer readable recording medium according to claim 11, wherein
the retrieval key candidate is formed of semantic symbols that are symbols obtained by executing a semantic analysis with respect to the two words.
